(19) United States
(12) Patent Application Publication
(10) Pub. No.: US 2025/0252241 A1
(43) Pub. Date: Aug. 7, 2025

(54) METHOD, SYSTEM AND DEVICE FOR MODELING MULTI-STATE MIXING PRECISION OF BATTERY ENERGY STORAGE CONTAINER

(71) Applicant: NORTH CHINA ELECTRIC POWER UNIVERSITY, BEIJING (CN)

(72) Inventors: XIAOHE YAN, BEIJING (CN); NIAN LIU, BEIJING (CN); JIALIANG LI, BEIJING (CN); LIANHAO SUN, BEIJING (CN)

(21) Appl. No.: 18/973,369

(22) Filed: Dec. 9, 2024

(30) Foreign Application Priority Data
Feb. 1, 2024 (CN) 202410137299.9

(51) Int. Cl. G06F 30/30; G01R 31/367; G01R 31/392; G01R 31/396

(52) U.S. Cl. CPC G06F 30/30; G01R 31/367; G01R 31/392; G01R 31/396

(57) ABSTRACT

A method, a system and a device for modeling multi-state mixing precision of a battery energy storage container are provided. The method includes: dividing a battery energy storage container into a four-level model; dividing states of the battery cells into five states according to SOHs of the battery cells; constructing a normal distribution model of the SOHs and determining the probability of each battery cell in each state; constructing a universal generating function of the battery cells; constructing the universal generating function of a battery pack, the universal generating function of a battery cluster, and the universal generating function of a battery compartment; and constructing an overall model of a five-state and four-level mixing precision energy storage battery compartment based on each universal generating function and an internal topological structure of the battery energy storage container.

### CROSS-REFERENCE TO RELATED APPLICATION

This patent application claims the benefit and priority of Chinese Patent Application No. 202410137299.9 filed with the China National Intellectual Property Administration on Feb. 1, 2024, the disclosure of which is incorporated by reference herein in its entirety as part of the present application.

### TECHNICAL FIELD

The present disclosure relates to the technical field of battery management, in particular to a method, a system and a device for modeling multi-state mixing precision of a battery energy storage container.

### BACKGROUND

New energy sources (such as wind energy and light energy) have been widely used in a power system and become a part of large-scale power grids. In order to solve the problem of fluctuation of wind energy and light energy, a battery energy storage system has become the most common choice. The safety and reliability of the battery energy storage system is very important for the operation of a wind and light storage station and the whole power system. Therefore, it is very necessary to evaluate the reliability of the battery energy storage system comprehensively and accurately. In the using process, the performance of an energy storage battery will gradually attenuate, resulting in the decrease of its available capacity. Because the battery attenuation has multiple states of health, the reliability under different capacity states is also different. Therefore, how to accurately describe the multiple states of the battery and take into account the uncertainty and fuzzy characteristics is crucial to evaluating the reliability of the energy storage battery system.

At present, the energy storage battery system consists of different battery cells in a modular way. The series-parallel connection relationship between battery cells needs to be taken into account, and an overall multi-state model is formed to evaluate the reliability of the whole energy storage system. Therefore, the multi-state model of the battery and the influence of the uncertainty and the fuzzy characteristics need to be taken into account in order to evaluate the reliability of the battery energy storage system. By accurately describing the multiple states of the battery and taking into account the interaction between different battery cells, the reliability of the energy storage system can be more accurately evaluated, thus improving the performance and the reliability of the whole system.

### SUMMARY

The present disclosure aims to provide a method, a system and a device for modeling multi-state mixing precision of a battery energy storage container, which realize the refined and rapid simulation of the battery energy storage container.

In order to achieve the above objective, the present disclosure provides the following solution.

A method for modeling multi-state mixing precision of a battery energy storage container is provided, including: dividing the battery energy storage container into a four-level model, which in sequence includes a battery cell level, a battery pack level, a battery cluster level, and a battery compartment level, where the battery compartment includes a plurality of battery clusters, each battery cluster includes a plurality of battery packs, and each battery pack includes a plurality of battery cells;
dividing states of the battery cells into five states according to the states of health (SOHs) of the battery cells, where the five states include excellence, attenuation, risk, defect and fault;
constructing a normal distribution model of the SOHs based on the five states of the battery cells and determining the probability of each battery cell in each state;
constructing a universal generating function of the battery cells based on the probability of each battery cell in each state and the SOH corresponding to each state;
constructing a universal generating function of the battery pack, a universal generating function of the battery cluster, and a universal generating function of the battery compartment based on the universal generating function of the battery cells; and
constructing an overall model of a five-state and four-level mixing precision energy storage battery compartment based on each universal generating function and an internal topological structure of the battery energy storage container.

In some embodiments, the universal generating function of the battery cell is:

$${u}_{j} ( z ) = {\sum }_{i = 1}^{5} {P}_{i}^{j} {z}^{{g}_{i}^{j}} ;$$

where uⱼ^{(z)} is a universal generating function value of the j-th battery cell; Pᵢ^{j} is the probability of the j-th battery cell being in the i-th state; z is a power coefficient; gᵢ^{j} is an SOH level of the i-th state for the j-th battery cell.

In some embodiments, the universal generating function of each battery pack is:

u_{pack}(z)=Ω(u₁(z), u₂(z), u₃(z), . . . , uⱼ(z), . . . , u_{N}(z));
where u_{pack}(z) is a universal generating function value of the battery pack; u₁(z) is a universal generating function value of a first battery cell; u₂(z) is a universal generating function value of a second battery cell; u₃(z) is a universal generating function value of a third battery cell; uⱼ(z) is a universal generating function value of the j-th battery cell; u_{N}(z) is a universal generating function value of the N-th battery cell; N is the number of battery cells in the battery pack; and Ω(·) is a series-parallel operation.

In some embodiments, the universal generating function of each battery cluster is:

u_{cluster}(z)=Ω(u_{pack1}(z), u_{pack2}(z), u_{pack3}(z), . . . , u_{packj1}(z), . . . , u_{packM}(z));
where u_{cluster}(z) is a universal generating function value of the battery cluster; u_{pack1}(z) is a universal generating function value of a first battery pack; u_{pack2}(z)is a universal generating function value of a second battery pack; u_{pack3}(z) is a universal generating function value of a third battery pack; u_{packj1}(z) is a universal generating function value of the j1-th battery pack; u_{packM}(z) is a universal generating function value of the M-th battery pack; and M is the number of battery packs in the battery cluster.

In some embodiments, the universal generating function of the battery compartment is:
where u_{bat}(z); is a universal generating function value of the battery compartment; u_{cluster1}(z) is a universal generating function value of a first battery cluster; u_{cluster2}(z) is a universal generating function value of a second battery cluster; u_{cluster3}(z) is a universal generating generating function value of a third battery cluster; u_{clusterj2}(z) is a universal generating function value of the j2-th battery cluster; u_{clusterK}(z) is a universal generating function value of the K-th battery cluster; and K is the number of battery clusters in the battery compartment.

In some embodiments, the overall model of the five-state and four-level mixing precision energy storage battery compartment is:

u_{bat}(z)=Ω(u_{cluster.normal1}(z), . . . , u_{cluster.normaln}(z), u_{cluster.fault}(z)).

where u_{bat}(z) is a universal generating function value of the battery compartment; u_{cluster.normal1}(z) is a universal generating function value of a first non-faulty battery cluster; u_{cluster.normaln}(z) is a universal generating function value of the n-th non-faulty battery cluster; and u_{cluster.fault}(z) is a universal generating function value of a faulty battery cluster.

A system for modeling multi-state mixing precision of a battery energy storage container is provided, including: a level dividing module, configured to divide the battery energy storage container into a four-level model, which in sequence includes a battery cell level, a battery pack level, a battery cluster level, and a battery compartment level, where the battery compartment includes a plurality of battery clusters, each battery cluster includes a plurality of battery packs, and each battery pack includes a plurality of battery cells;
a state dividing module, configured to divide states of the battery cells into five states according to the states of health (SOHs) of the battery cells, where the five states include excellence, attenuation, risk, defect and fault;
a normal distribution model constructing module, configured to construct a normal distribution model of the SOHs based on the five states of the battery cell and determine the probability of each battery cell in each state;
a first function constructing module, configured to construct a universal generating function of the battery cells based on the probability of each battery cell in each state and the SOH corresponding to each state;
a second function constructing module, configured to construct a universal generating function of the battery pack, a universal generating function of the battery cluster, and a universal generating function of the battery compartment based on the universal generating function of the battery cells; and
an overall model constructing module, configured to construct an overall model of a five-state and four-level mixing precision energy storage battery compartment based on each universal generating function and an internal topological structure of the battery energy storage container.

A device is provided, including a memory, a processor, and a computer program stored in the memory, where the processor operates the computer program to cause the device to implement the method for modeling multi-state mixing precision of the battery energy storage container described above.

In some embodiments, the memory is a readable storage medium.

According to the specific embodiments provided by the present disclosure, the present disclosure provides the following technical effects. The present disclosure provides a method, a system and a device for modeling multi-state mixing precision of a battery energy storage container. The method includes: first, dividing the battery energy storage container into a four-level model; where the four-level model in sequence includes a battery cell level, a battery pack level, a battery cluster level, and a battery compartment level, where the battery compartment includes a plurality of battery clusters, each battery cluster includes a plurality of battery packs, and each battery pack includes a plurality of battery cells; dividing states of the battery cells into five states according to the states of health (SOHs) of the battery cells, where the five states include excellence, attenuation, risk, defect and fault; second, constructing a normal distribution model of the SOHs based on the five states of the battery cells and determining the probability of each battery cell in each state; thereafter, constructing a universal generating function of the battery cells based on the probability of each battery cell in each state and the SOH corresponding to each state; constructing the universal generating function of the battery pack, the universal generating function of the battery cluster, and the universal generating function of the battery compartment based on the universal generating function of the battery cells; and finally, constructing an overall model of a five-state and four-level mixing precision energy storage battery compartment based on each universal generating function and an internal topological structure of the battery energy storage container, thus realizing the refined and rapid simulation of the battery energy storage container.

### BRIEF DESCRIPTION OF THE DRAWINGS

In order to explain the embodiments of the present disclosure or the technical solutions in the prior art more clearly, the drawings that need to be used in the embodiments will be briefly introduced. Obviously, the drawings in the following description are only some embodiments of the present disclosure. For those skilled in the art, other drawings can be obtained according to these drawings without creative labor.

FIG. 1 is a schematic flow chart of a method for modeling multi-state mixing precision of a battery energy storage container according to Embodiment 1 of the present disclosure.

FIG. 2 is a schematic diagram of a multi-state refined model of distributed energy storage.

FIG. 3 is a schematic diagram of a process of finely modeling multi-state mixing precision of a battery energy storage container.

### DETAILED DESCRIPTION OF THE EMBODIMENTS

The technical solutions in the embodiments of the present disclosure will be clearly and completely described with reference to the drawings in the embodiments of the present disclosure hereinafter. Obviously, the described embodiments are only some embodiments of the present disclosure, rather than all of the embodiments. Based on the embodiment of the present disclosure, all other embodiments obtained by those skilled in the art without creative labor fall within the scope of protection of the present disclosure.

The purpose of the present disclosure is to provide a method, a system and a device for modeling multi-state mixing precision of a battery energy storage container, aiming at realizing the refined and rapid simulation of the battery energy storage container.

In order to make the above objects, features and advantages of the present disclosure more obvious and understandable, the present disclosure will be explained in further detail with reference to the drawings and detailed description hereinafter.

Embodiment 1 provides a method for modeling multi-state mixing precision of a battery energy storage container.

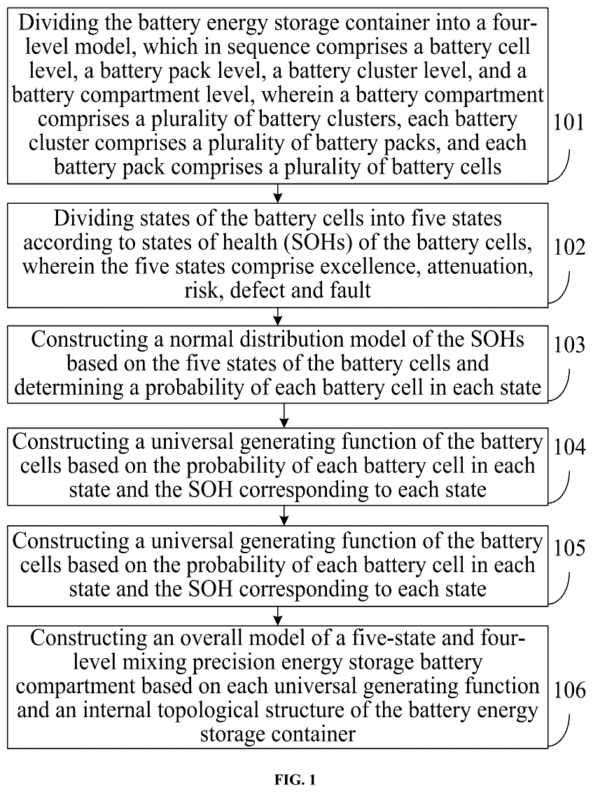

FIG. 1 is a schematic flow chart of a method for modeling multi-state mixing precision of a battery energy storage container according to Embodiment 1 of the present disclosure. As shown in FIG. 1, the method for modeling multi-state mixing precision of the battery energy storage container in this embodiment includes step 101 to step 106.

In step 101, a battery energy storage container is divided into a four-level model, which in sequence includes levels of a battery cell, a battery pack, a battery cluster, and a battery compartment. Where each battery compartment includes a plurality of battery clusters, each battery cluster includes a plurality of battery packs, and each battery pack includes a plurality of battery cells.

In step 102, states of the battery cells are divided into five states according to the states of health (SOHs) of the battery cells, where the five states include: excellence, attenuation, risk, defect and fault.

In step 103, based on the five states of the battery cells, a normal distribution model of the SOHs is constructed and the probability of each battery cell in each state is determined.

In step 104, a universal generating function of the battery cells is constructed based on the probability of each battery cell in each state and the SOH corresponding to each state.

In some embodiments, the universal generating function of the battery cell is as follows:

$${u}_{j} ( z ) = {\sum }_{i = 1}^{5} {P}_{i}^{j} {z}^{{g}_{i}^{j}} \qquad ( 1 )$$

where uⱼ(z) is a universal generating function value of the j-th battery cell; Pᵢ^{j} is the probability of the j-th battery cell being in the i-th state; z is a power coefficient; gᵢ^{j} is an SOH level of the i-th state for the j-th battery cell.

In step 105, the universal generating function of the battery pack, the universal generating function of the battery cluster, and the universal generating function of the battery compartment are constructed based on the universal generating function of the battery cells.

In some embodiments, the universal generating function of the battery pack is as follows:

$${u}_{pack} ( z ) = Ω ( {u}_{1} ( z ) , {u}_{2} ( z ) , {u}_{3} ( z ) , … , {u}_{j} ( z ) , … , {u}_{N} ( z ) ) \qquad ( 2 )$$

where u_{pack}(z) is a universal generating function value of the battery pack; u₁(z) is a universal generating function value of a first battery cell; u₂(z) is a universal generating function value of a second battery cell; u₃(z) is a universal generating function value of a third battery cell; uⱼ(z) is a universal generating function value of the j-th battery cell; u_{N}(z) is a universal generating function value of the N-th battery cell; N is the number of battery cells in the battery pack; and Ω(·) is a series-parallel operation.

In some embodiments, the universal generating function of the battery cluster is as follows:

$${u}_{cluster} ( z ) = Ω ( {u}_{pack 1} ( z ) , {u}_{pack 2} ( z ) , {u}_{pack 3} ( z ) , … , {u}_{packj 1} ( z ) , … , {u}_{packM} ( z ) ) \qquad ( 3 )$$

where u_{cluster}(z) is a universal generating function value of the battery cluster; u_{pack1}(z) is a universal generating function value of a first battery pack; u_{pack2}(z) is a universal generating function value of a second battery pack; u_{pack3}(z) is a universal generating function value of a third battery pack; u_{packj1}(z) is a universal generating function value of the j1-th battery pack; u_{packM}(z) is a universal generating function value of the M-th battery pack; and M is the number of battery packs in the battery cluster.

In some embodiments, the universal generating function of the battery compartment is as follows:

$$( 4 )$$

$$\text{?} ( z ) = Ω ( {u}_{cluster 1} ( z ) , {u}_{cluster 2} ( z ) , {u}_{cluster 3} ( z ) , … , {u}_{clusterj 2} ( z ) , … {u}_{clusterK} ( z ) )$$

$$\text{?} \text{indicates text missing or illegible when filed}$$

where u_{bat}(z) is a universal generating function value of the battery compartment; u_{cluster1}(z) is a universal generating function value of a first battery cluster; u_{cluster2}(z) is a universal generating function value of a second battery cluster; u_{cluster3}(z) is a universal generating function value of a third battery cluster; u_{clusterj2}(z) is a universal generating function value of the j2-th battery cluster; u_{clusterK}(z) is a universal generating function value of the K-th battery cluster; and K is the number of battery clusters in the battery compartment.

In step 106, an overall model of a five-state and four-level mixing precision energy storage battery compartment is constructed based on each universal generating function and an internal topological structure of the battery energy storage container.

In some embodiments, the overall model of the five-state and four-level mixing precision energy storage battery compartment is as follows:

$${u}_{bat} ( z ) = Ω ( {u}_{cluster . normal 1} ( z ) , … , {u}_{cluster . norma ln} ( z ) , {u}_{cluster . fault} ( z ) ) \qquad ( 5 )$$

where u_{bat}(z) is a universal generating function value of the battery compartment; u_{cluster.normal1}(z) is a universal generating function value of a first non-faulty battery cluster; u_{cluster.normaln}(z) is a universal generating function value of the n-th non-faulty battery cluster; and u_{cluster.fault}(z) is a universal generating function value of a faulty battery cluster.

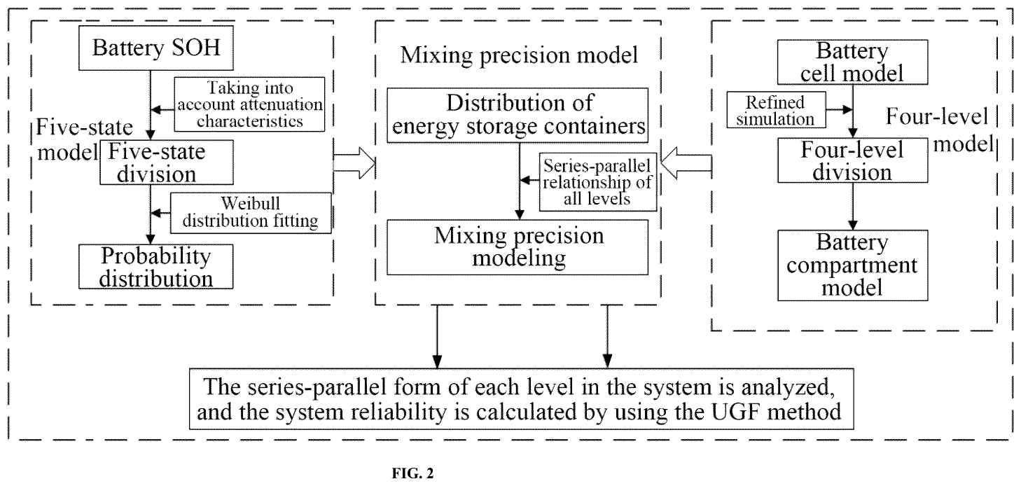

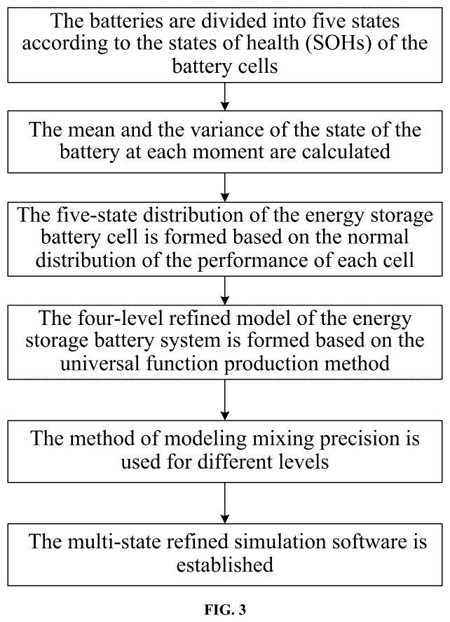

As shown in FIG. 2 and FIG. 3, in order to implement the method in Embodiment 1, a method for finely modeling multi-state mixing precision of a battery energy storage container is further provided, including step 1 to step 5.

In step 1, the deterioration severity of the battery module can be quantified by the State Of Health (SOH) of the battery cell. The SOH can be used to indicate the ongoing or sudden deterioration of batteries, which is a measurement method to reflect the performance and the SOH of the battery. Therefore, the SOH is an important parameter of the reliability analysis of the battery module. The SOH is defined as the ratio of the maximum rated capacity of the battery at the present stage to the maximum rated capacity of the battery at the initial moment. At the initial moment, the SOH of the battery is 100%. When the SOH of the battery cell drops to a specific threshold, the battery cell is considered as a fault component.

$$SOH = \frac{Q}{{Q}_{st}} = \frac{{Q}_{st} - {Q}_{loss}}{{Q}_{st}} \qquad ( 6 )$$

where Q is the maximum charging capacity of an aging battery cell; Qₛₜ is the maximum charging capacity of a new battery cell; Qₗₒₛₛ is the capacity loss (attenuation) of the battery cell.

Based on the capacity attenuation model of the battery, the SOH attenuation change of the battery is calculated, and the calculated SOH of the battery at each moment is taken as an mean of the normal distribution of the battery at each moment.

Taking a lithium iron phosphate battery as an example, the factors that influence the capacity attenuation can be summarized as the temperature, the charging/discharging depth and the charging/discharging rate. Through interpolation and fitting of experimental data, the expression of the final capacity attenuation can be obtained as follows.

$$Δ {Q}_{fade} = \frac{{Q}_{loss}}{{Q}_{st}} = B \cdot exp ( \frac{- 31700 + 370.3 \times C}{RT} ) \cdot ( Ah \text{?} \qquad ( 7 )$$

$$\text{?} \text{indicates text missing or illegible when filed}$$

where ΔQ_{fade} is a ratio of the capacity loss to the maximum charging capacity; B is a parameter factor, and the value of the parameter factor decreases with the increase of the charging/discharging rate; R is a gas constant, which is equal to 8.31 J/mol·K; T is the absolute temperature; C is the charging/discharging rate; Ah is the total current flow, which is directly proportional to the time of each charging/discharging, Ah=n_{c}·DOD·Q, n_{c} is the number of battery cycles, and DOD is the discharging depth; and z is a power coefficient, and z is equal to 0.55 for lithium ion batteries.

The expression of the change of the SOH of battery (that is, the average of battery distribution) with time is as follows.

$$μ ( t ) = {μ}_{0} - B \cdot exp ( \frac{- 31700 + 370.3 \times C}{RT} ) \cdot ( {Q}_{ini} \times DOD \times C \times t \text{?} \qquad ( 8 )$$

$$\text{?} \text{indicates text missing or illegible when filed}$$

where μ(t) is the SOH of the battery at moment ; μ₀ is the SOH of the battery at the initial moment; and Qᵢₙᵢ is the capacity of the battery at the initial moment, and when the SOH at the initial moment is 100%, Qᵢₙᵢ=Qₛₜ.

Based on the SOHs of the battery, the states of health of the battery are divided into five states including excellence, attenuation, risk, defect, and fault. Each state corresponds to a different probability value. Taking the j-th battery cell as an example, the states of health are divided into five different states of excellence, attenuation, risk, defect, fault according to its SOHs. The different states are denoted by g₁, g₂, g₃, g₄ and g₅, respectively. The state set g^{j} corresponding to the j-th battery cell is: {g₁^{j} [symbol] g₂^{j} [symbol] g₃^{j} [symbol] g₄^{j} [symbol] g₅^{j}}, in which g₁^{j} is the SOH level of the first state for the j-th battery cell; g₂^{j} is the SOH level of the second state for the j-th battery cell; g₃^{j} is the SOH level of the third state for the j-th battery cell; g₄^{j} is the SOH level of the fourth state for the j-th battery cell; g₅^{j} is the SOH level of the fifth state for the j-th battery cell.

Each divided state corresponds to a different SOH value: g₁^{j}=[SOH_{i_lower}, SOH_{i_upper}], in which gᵢ^{j} is the SOH level of the i-th state for the j-th battery cell; SOH_{i_lower}is the SOH lower limit of the SOH level for the i-th state; and SOH_{i_upper}is the SOH upper limit of the SOH level for the i-th state.

According to the SOH attenuation curve of a lithium battery cell and the practical application requirements of reliability, the above five performance states are divided into excellence: 90% to 100%, attenuation: 80% to 90%, risk: 60% to 80%, defect: 20% to 60% and fault: 0% to 20% according to the SOH value. Different state intervals correspond to different probabilities, and its probability set Pⱼ can be denoted as: {P₁^{j} [symbol] P₂^{j} [symbol] 32 P₃^{j} [symbol] P₄^{j} [symbol] P₅^{j}}. P₁^{j} is the probability of the j-th battery cell being in the first state; P₂^{j} is the probability of the j-th battery cell being in the second state; P₃^{j} is the probability of the j-th battery cell being in the third state; P₄^{j} is the probability of the j-th battery cell being in the fourth state; P₅^{j} is the probability of the j-th battery cell being in the fifth state.

At any moment f, the j-th battery cell can only be in one performance state in g^{j}, and its probability is the corresponding value in Pⱼ. In order to calculate the reliability of the battery module by using the SOH method, it is assumed that the electrochemical characteristics of the battery cells in the battery module are the same at the beginning moment, and they are all in the perfect working condition. At other moments, the SOH levels of a large number of batteries follow the normal distribution N(μ, σ²) at any moment. When the battery cell operates, the SOH starts to decrease from 1, and the standard deviation σ begins to increase with the performance attenuation. The standard deviation is defined as:

$$σ ( t ) = \frac{1 - μ ( t )}{6} .$$

σ(t) is the standard deviation at moment t.

Therefore, a large number of battery cells obey a normal distribution with an mean of μ(t) and a variance of σ(t) as a whole. Because the variance of the overall distribution is also unknown and the overall battery performance distribution is normal, the variance can be approximately replaced by the variance of the samples. When the number of samples is large, the mean of the samples still conforms to the normal distribution.

In step 2: based on the normal distribution model constructed in step 1, the states of health of the battery are divided into five states, and the probability of the energy storage battery in each state is solved.

The probability that the state of the j-th battery cell falls within a certain interval [SOH_{i_lower}, SOH_{i_upper}] (that is, falls within the state gᵢ^{j}) can be denoted as Pᵢ^{j} and the calculation formula is as follows.

$${P}_{i}^{j} = {\int }_{{SOH}_{i \_ lower}}^{{SOH}_{i \_ upper}} f ( t ) dt = F ( SO \text{?} ) - F ( {SOH}_{i \_ lower} ) \qquad ( 9 )$$

$$\text{?} \text{indicates text missing or illegible when filed}$$

where f(t) is a probability density function, and F(·) is a normal distribution function.

Taking into account the SOH attenuation curve of the energy storage battery cell model and the practical application requirements of reliability, the five performance states of excellence, attenuation, risk, defect and fault are divided into excellence: 90% to 100%, attenuation: 80% to 90%, risk: 60% to 80%, defect: 20% to 60% and fault: 0% to 20% in sequence according to the SOH value.

$${SOH}_{i \_ lower} = \{ \begin{matrix}0.9 , i = 1 \\ 0.8 , i = 2 \\ 0.6 , i = 3 \\ 0.2 , i = 4 \\ 0 , i = 5\end{matrix} , {SOH}_{i \_ upper} = \{ \begin{matrix}1 , i = 1 \\ 0.9 , i = 2 \\ 0.8 , i = 3 \\ 0.6 , i = 4 \\ 0.2 , i = 5\end{matrix} .$$

Therefore, the probability of the j-th battery cell in each state is reconstructed as: Pⱼ∈{P₁^{j} [symbol] P₂^{j} [symbol] P₃^{j} [symbol] P₄^{j} [symbol] P₅^{j}}.

In step 3: based on the methods proposed in step 1 and step 2, a fuzzy multi-state model (that is, fuzzy multi-state distribution) of the battery cell can be formed, and then a four-level refined model of the energy storage container, which includes levels of the battery cell, the battery pack, the battery cluster and the battery compartment, can be constructed. The universal generating function method is used to form the universal generating function of the energy storage battery cell, and universal function operators are constructed step by step to form the universal generating functions of the battery pack, the battery cluster and the battery compartment.

For the j-th battery cell, the universal generating function thereof can be denoted as the formula (1).

The energy storage battery module is formed by connecting a large number of energy storage battery cells in series and parallel. For the battery cells connected in series, the overall reliability thereof should be determined by the battery cell in the worst condition. For the battery cells connected in parallel, in order to reflect the overall performance level of the battery more comprehensively and accurately, the rule of the weighted combination operation is proposed, which allocates the highest weight to the battery cell with the best performance state and allocates the lower weight to the battery cell with poor performance state. Finally, the performance state of the parallel structure is obtained by the weighted combination of all parts. An analytic hierarchy process can be used to obtain the specific weight.

$$Φ ( {g}_{i}^{1} , {g}_{i}^{2} , {g}_{i}^{3} , … {g}_{i}^{j} , … , {g}_{i}^{N} ) = \{ \begin{matrix}{f}_{1} ( {g}_{i}^{1} , {g}_{i}^{2} , {g}_{i}^{3} , … {g}_{i}^{j} , … , {g}_{i}^{N} ) , series structure \\ {f}_{2} ( {g}_{i}^{1} , {g}_{i}^{2} , {g}_{i}^{3} , … {g}_{i}^{j} , … , {g}_{i}^{N} ) , parallel structure\end{matrix} \qquad ( 10 )$$

where f₁(gᵢ¹,gᵢ²,g₃^{j}, . . . , gᵢ^{j}, . . . , gᵢ^{N}) is a random variable function in a series structure mode; and f₂(gᵢ¹,gᵢ²,g₃^{j}, . . . , gᵢ^{j}, . . . , gᵢ^{N})is a random variable function in a parallel structure mode.

$${f}_{1} ( {g}_{i}^{1} , {g}_{i}^{2} , \text{?} , … {g}_{i}^{j} , … , \text{?} ) = min {f}_{1} ( {g}_{i}^{1} , {g}_{i}^{2} , {g}_{i}^{3} , … {g}_{i}^{j} , … , {g}_{i}^{N} ) \qquad ( 11 )$$

$${f}_{2} ( {g}_{i}^{1} , {g}_{i}^{2} , {g}_{i}^{3} , … {g}_{i}^{j} , … , {g}_{i}^{N} ) = {β}_{1} {g}_{i}^{1} + {β}_{2} {g}_{i}^{2} + {β}_{3} {g}_{i}^{3} + … + {β}_{n} {g}_{i}^{N} \qquad ( 12 )$$

$$\text{?} \text{indicates text missing or illegible when filed}$$

where gᵢ¹ is the SOH level of the i-th state for the first battery cell; gᵢ² is the SOH level of the i-th state for the second battery cell; gᵢ³ is the SOH level of the i-th state for the third battery cell; gᵢ^{j} is the SOH level of the i-th state for the j-th battery cell; gᵢ^{N} is the SOH level of the i-th state for the N-th battery cell; β₁ is the weight of the first battery cell; β₂ is the weight of the second battery cell; β₃ is the weight of the third battery cell; and βₙ is the weight of the N-th battery cell.

The energy storage battery module is constructed by first connecting battery cells in series and parallel to form a battery pack, connecting the battery packs according to a certain series-parallel relationship to form a battery cluster, and then connecting the battery clusters according to a certain series-parallel relationship to form an integral battery compartment module.

The universal generating function of the battery pack formed by connecting N energy storage battery cells according to the series-parallel relationship is as follows.

$$( 13 )$$

$${u}_{pack} ( z ) = Ω ( {u}_{1} ( z ) , {u}_{2} ( z ) , {u}_{3} ( z ) , … {u}_{j} ( z ) , … , {u}_{N} ( z ) ) = Ω ( {\sum }_{i = 1}^{n} {P}_{i}^{1} {z}^{{g}_{i}^{1}} , {\sum }_{i = 1}^{n} {P}_{i}^{2} {z}^{{g}_{i}^{2}} , {\sum }_{i = 1}^{n} {P}_{i}^{3} {z}^{{g}_{i}^{3}} , … {\sum }_{i = 1}^{n} {P}_{i}^{j} {z}^{{g}_{i}^{j}} , … {\sum }_{i = 1}^{n} {P}_{i}^{N} {z}^{{g}_{i}^{N}} ) = {\sum }_{i = 1}^{n} {\tilde{P}}_{a , i} {z}^{{g}_{a , i}}$$

where u_{pack}(z) is a universal generating function value of the battery pack; u₁(z) is a universal generating function value of a first battery cell; u₂(z) is a universal generating function value of a second battery cell; u₃(z) is a universal generating function value of a third battery cell; uⱼ(z) is a universal generating function value of the j-th battery cell; u_{N}(z) is a universal generating function value of the N-th battery cell; Pᵢ¹ is the probability of the first battery cell being in the i-th state; gᵢ¹ is the SOH level of the i-th state for the first battery cell; Pᵢ² is the probability of the second battery cell being in the i-th state; gᵢ² is the SOH level of the i-th state for the second battery cell; Pᵢ³ is the probability of the third battery cell being in the i-th state; gᵢ³ is the SOH level of the i-th state for the third battery cell; Pᵢ^{j} is the probability of the j-th battery cell being in the i-th state; gᵢ^{j} is the SOH level of the i-th state for the j-th battery cell; Pᵢ^{N} is the probability of the N-th battery cell being in the i-th state; gᵢ^{N} is the SOH level of the i-th state for the N-th battery cell; n is the number of states, n=5; \tilde{P}_{a,i} is the probability of the battery pack being in the i-th state; g_{a,i} is the SOH level of the i-th state for the battery pack.

Thereafter, M battery packs form a battery cluster module through the series-parallel relationship, and the universal generating function of the battery cluster is as follows. PGP-44,E

$${u}_{cluster} ( z ) = Ω ( {u}_{pack 1} ( z ) , {u}_{pack 2} ( z ) , {u}_{pack 3} ( z ) , … , {u}_{packj} ( z ) , … , {u}_{packM} ( z ) ) = {\sum }_{i = 1}^{n} {\tilde{P}}_{b , i} {z}^{{g}_{b , i}} \qquad ( 14 )$$

where u_{cluster}(z)is a universal generating function value of the battery cluster; u_{pack1}(z)is a universal generating function value of a first battery pack; u_{pack2}(z)is a universal generating function value of a second battery pack; u_{pack3}(z)is a universal generating function value of a third battery pack; u_{packj1}(z)is a universal generating function value of the j1-th battery pack; u_{packM}(z) is a universal generating function value of the M-th battery pack; M is the number of battery packs in the battery cluster; \tilde{P}_{b,i} is the probability of the battery cluster being in the i-th state; g_{b,i} is the SOH level of the i-th state for the battery cluster.

Finally, K battery clusters form a battery compartment module through the series-parallel relationship, and the generating function of the battery compartment is as follows.

$${u}_{bat} ( z ) = Ω ( {u}_{cluster 1} ( z ) , {u}_{cluster 2} ( z ) , {u}_{cluster 3} ( z ) , … , {u}_{clusterj 2} ( z ) , … , {u}_{clusterK} ( z ) ) = {\sum }_{i = 1}^{n} {\tilde{P}}_{c , i} \text{?} \qquad ( 15 )$$

$$\text{?} \text{indicates text missing or illegible when filed}$$

where u_{bat}(z) is a universal generating function value of the battery compartment; u_{cluster1}(z)is a universal generating function value of a first battery cluster; u_{cluster2}(z) is a universal generating function value of a second battery cluster; u_{cluster3}(z) is a universal generating function value of a third battery cluster; u_{clusterj2}(z)is a universal generating function value of the j2-th battery cluster; u_{clusterK}(z) is a universal generating function value of the K-th battery cluster; \tilde{P}_{c,i} is the probability of the battery compartment being in the i-th state; g_{c,i} is the SOH level of the i-th state for the battery compartment.

In step 4, taking into account the problems such as the complex operation structure and the slow calculation speed of the multi-level energy storage model in the actual operation, a method for modeling mixing precision for different levels in different scenarios is proposed according to the internal topological structure characteristics of the energy storage container, which greatly improves the simulation calculation speed.

When the battery compartment is in normal operation, the normal distributions of various modules are different, because different battery clusters of each module have different use times and thus the states of health thereof are different. The battery module in the state of excellence (that is, the SOH value is higher than 90%) is modeled as a whole by using the battery cluster (that is, the formula 14); the battery module in the states of attenuation and risk (that is, the SOH value is 60% to 90%) is modeled as a whole by using the battery pack (that is, the formula 13); and the battery module in the states of defect and fault (that is, the SOH value is 0% to 60%) is modeled by using the battery cell. The universal generating function (UGF) method is used to model the mixing precision of different modules in sequence, and finally the five-state and four-level mixing precision of the battery compartment is modeled as a whole by the formula (15).

When the temperature of a certain battery cell in the battery compartment exceeds the criterion and a thermal runaway fault occurs, the energy storage model is finely modeled considering the propagation range of the battery fault in the predicted time. Taking into account the thermal runaway propagation process of the battery energy storage system, based on the topological structure inside the energy storage battery compartment, the spacing between the battery cells, and the state of charge of the battery, the propagation range of the internal faults in the battery compartment is determined, and then different battery compartment modules are classified and modeled. The modeling types influenced by the faulty battery cells are classified.

First, the influence range of the faulty battery cell f at moment t is determined. Taking into account the thermal propagation of the faulty battery cell f upon occurrence of a thermal runaway fault, the nearby battery cell e absorbs the energy E_{f,e} of the battery cell f as follows.

$${E}_{f , e} = \text{?} {P}_{f} ( τ ) {η}_{f , e} d τ \qquad ( 16 )$$

$$\text{?} \text{indicates text missing or illegible when filed}$$

where P_{f}(τ) is the heat release power of the battery cell f at moment τ; t_{f0} is the moment when the battery cell f triggers thermal runaway; and n_{f,e} is the efficiency of energy transfer from the battery cell fto the battery cell e.

$${P}_{f} ( τ ) = P ( τ ) \times \frac{{SOC}_{f} ( {t}_{f 0} ) {n}_{f} ( {t}_{f 0} )}{{k}_{f}} \qquad ( 17 )$$

$${η}_{f , e} = \{ \begin{matrix}\frac{\text{?}}{{d}_{f , e}} + \frac{\text{?}}{\text{?}} , {d}_{f , e} \leq {d}_{0 , f} \\ 0 , {d}_{f , e} > {d}_{0 , f}\end{matrix} \qquad ( 18 )$$

$$\text{?} \text{indicates text missing or illegible when filed}$$

where P(τ) is the heat release power in the heat release rate curve for typical battery thermal runaway type to which the battery cell f belongs, at moment τ, SOC_{f}(t_{f0}) is the state of charge when the battery f triggers thermal runaway; n_{f}(t_{f0})is the number of normal parallel branches flowing through the battery cell f, k_{f} is a constant; ηₜₕₑ is the reference efficiency of heat conduction in a given environment; d_{f,e} is the spacing between the battery cell f and the battery cell e; ηₜₕᵣ is the reference efficiency of thermal radiation in a given environment; d_{0,f} is the effective heat transfer range of thermal runaway.

Due to a large amount of heat absorption, the working environment temperature of the battery cell e keeps rising, and its temperature reaches the critical temperature T_{c} of thermal runaway as the triggering criterion of thermal runaway.

$$\text{?} ( t ) = \{ \begin{matrix}max ( \text{?} ( t - 1 ) , 0 ) , \text{?} ( t ) < {T}_{c} \\ 1 , \text{?} ( t ) \geq {T}_{c}\end{matrix} \qquad ( 19 )$$

$$\text{?} ( t ) = \text{?} ( \text{?} ) + {\sum }_{f} \frac{\text{?} ( t )}{\text{?}} , f ∈ \{ {λ}_{f} ( t ) = 1 \} \qquad ( 20 )$$

$$\text{?} \text{indicates text missing or illegible when filed}$$

where λₑ(t) is an index to determine whether the battery cell e has thermal runaway at moment t; λₑ(t−1) is an index to determine whether the battery cell e has thermal runaway at moment t−1; Tₑ(t) is the temperature of the battery cell e at moment Tₑ(t_{f0}) is the temperature of the battery cell e upon triggering the thermal runaway; E_{f,e}(t) is the energy of the battery cell f absorbed by the battery cell e at moment t; cₑ is the specific heat capacity of the battery cell e; mₑ is the mass of the battery cell e; and λ_{f}(t)is an index to determine whether the battery cell f occurs thermal runaway at moment t, and when the battery cell f occurs thermal runaway at moment t, λ_{f}(t)=1.

Second, the battery cell with thermal runaway is regarded as a load, and the SOH value is 0. The normal battery cell in the external circuit inputs electric energy to the battery cell to generate Joule heat, which accelerates heat release of the battery cell and increases the maximum temperature of thermal runaway. Therefore, the random variable function of the connection structure including the battery cells suffering from thermal runaway is as follows.

$$Φ ( {g}_{i}^{1} , {g}_{i}^{2} , {g}_{i}^{3} , … {g}_{i}^{j} , … , {g}_{i}^{N} ) = \{ \begin{matrix}0 , series structure \\ {β}_{1} {g}_{i}^{1} + {β}_{2} {g}_{i}^{2} + … + {β}_{n} {g}_{i}^{N} , parallel structure\end{matrix} \qquad ( 21 )$$

According to the temperature interval, the battery cells within the propagation range of thermal runaway are divided into three kinds of normal distribution curves, namely normal operation, accelerated attenuation and thermal runaway as follows.

$${T}_{e} ( t ) ∈ \{ \begin{matrix}[ \text{?} , {T}_{safe} ] , e ∈ {W}_{1} \\ [ {T}_{safe} , {T}_{c} ] , e ∈ {W}_{2} \\ [ \text{?} + ∞ ] , e ∈ {W}_{3}\end{matrix} \qquad ( 22 )$$

$$\text{?} \text{indicates text missing or illegible when filed}$$

where Tₑₘₑ is the ambient temperature of the battery cell e; T_{safe} is the highest temperature for the safe operation of battery cells (generally 40° C.); e∈W₁ indicates that the battery cell e obeys the first normal distribution; e∈W₂ indicates that the battery cell e obeys the second normal distribution; e∈W₃ indicates that the battery cell e obeys the third normal distribution.

Finally, the modeling types are divided into three sets: A, B and C, in which set A is the battery packs where the fault cells and the battery cells in the propagation range of the fault cells at moment t are located, and the refined cell modeling is adopted; set B is the battery packs in the battery cluster containing faulty battery cells, where the battery cells outside the propagation range at moment t are located, and the battery pack overall modeling is adopted; set C is a non-faulty battery cluster, and the battery cluster overall modeling is adopted. The calculation formula of the three fault sets is as follows.

$$\{ \begin{matrix}A = G \\ G = Y - G \\ C = U - Y\end{matrix} \qquad ( 23 )$$

where G is the influence range of the propagation fault of thermal runaway at moment t; Y is the structural range contained in the battery cluster having faulty battery cells; U is the structural range contained in all battery clusters.

For a certain fault in the battery compartment, there are k battery clusters containing the fault. x battery packs influenced by the fault range and h battery packs not influenced by the fault range exist in the battery cluster where a fault occurs. Each battery pack contains y series-parallel battery cells. In addition, there are d non-faulty battery clusters in the compartment. The method for finely modeling the battery compartment is as follows.

The battery pack refined model influenced by the fault range is established as follows.

$${u}_{pack . fault . ξ 1} ( z ) = Ω ( {u}_{1} ( z ) , {u}_{2} ( z ) , {u}_{3} ( z ) , … , {u}_{y} ( z ) ) = Ω ( {\sum }_{i = 1}^{5} {\tilde{P}}_{i}^{1} {z}^{{g}_{i}^{1}} , {\sum }_{i = 1}^{5} {\tilde{P}}_{i}^{2} {z}^{{g}_{i}^{2}} , {\sum }_{i = 1}^{5} {\tilde{P}}_{i}^{3} {z}^{{g}_{i}^{3}} , … , {\sum }_{i = 1}^{5} {\tilde{P}}_{i}^{y} {z}^{{g}_{i}^{y}} ) = {\sum }_{i = 1}^{5} … {\sum }_{i = 1}^{5} {\tilde{P}}_{i}^{1} … {\tilde{P}}_{i}^{y} {z}^{Φ ( {g}_{i}^{1} , {g}_{i}^{2} … , {g}_{i}^{y} )} = {\sum }_{i = 1}^{5} {\tilde{P}}_{y , i} {z}^{{g}_{y , i}} , ξ 1 ∈ A \qquad ( 24 )$$

where u_{pack.fault.ξ1}(z) is the universal generating function value of the battery pack ξ1 belonging to set u₁(z) is the universal generating function value of the first battery cell; u₂(z) is the universal generating function value of the second battery cell; u₃(z) is the universal generating function value of the third battery cell; u_{y}(z) is the universal generating function value of the y-th battery cell; \tilde{P}ᵢ^{y} is the probability of the y-th battery cell being in the i-th state; gᵢ^{y} is the SOH level of the i-th state for the y-th battery cell; \tilde{P}_{y,i} is the probability that the battery pack formed by connecting y battery cells in series and parallel and influenced by the fault range is in the i-th state; g_{y,i} is the SOH level of the i-th state for the battery pack formed by connecting y battery cells in series and paralle and influenced by the fault range 1.

For the battery pack (set B) outside the fault range and the non-faulty battery cluster (set C), the overall modeling method is the same as the modeling method of the battery cell. That is, the five-state performance level is divided based on the overall SOH value of the battery pack/battery cluster, and the probability value of each state is determined by its normal distribution model, so as to obtain the corresponding universal generating function.

The overall models of the non-faulty battery pack and the non-faulty battery cluster are established as follows.

$$\text{?} ( z ) = \text{?} , ξ 2 ∈ B \qquad ( 25 )$$

$$\text{?} ( z ) = \text{?} , ξ 3 ∈ C \qquad ( 26 )$$

$$\text{?} \text{indicates text missing or illegible when filed}$$

where u_{pack.fault.ξ2}(z) is the universal generating function value of the battery pack ξ2 belonging to set B; \tilde{P}_{h,i} is the probability that the non-faulty battery pack formed by connecting h battery cells in series and parallel is in the i-th state; g_{h,i} is the SOH level of the i-th state for the non-faulty battery pack formed by connecting h battery cells in series and parallel; u_{pack.fault.ξ3}(z) is the universal generating function value of the battery cluster ξ3 belonging to set C; \tilde{P}_{d,i} is the probability that the non-faulty battery cluster formed by connecting d battery packs in series and parallel is in the i-th state; g_{d,i} is the SOH level of the i-th state for the non-faulty battery cluster formed by connecting d battery packs in series and parallel.

According to the formula (24) and the formula (25), the five-state mixing precision model of the faulty battery cluster is established as follows.

$$( 27 )$$

$${u}_{cluster . fault} ( z ) = Ω ( {u}_{pack . fault 1} ( z ) , … , {u}_{pack . faultx} ( z ) , {u}_{pack . normal 1} ( z ) , … , {u}_{pack . normalh} ( z ) ) = {\sum }_{i = 1}^{5} … {\sum }_{i = 1}^{5} {\sum }_{i = 1}^{5} … {\sum }_{i = 1}^{5} {P}_{i}^{1} … {P}_{i}^{x} {P}_{i}^{1} … {P}_{i}^{h} {z}^{Φ ( {g}_{i}^{1} {…g}_{i}^{x} , {g}_{i}^{1} … , {g}_{i}^{h} )} = {\sum }_{i = 1}^{5} {\tilde{P}}_{f , i} {z}^{{g}_{f , i}}$$

u_{cluster.fault}(z) where is the universal generating function value of the faulty battery cluster; u_{pack.fault1}(z) is the universal generating function value of the first faulty battery pack in the faulty battery cluster; u_{pack.faultx}(z) is the universal generating function value of the x-th faulty battery pack in the faulty battery cluster; u_{pack.normal1}(z) is the universal generating function value of the first non-faulty battery pack in the faulty battery cluster; u_{pack.normalh}(z)is the universal generating function value of the h-th non-faulty battery pack in the faulty battery cluster; Pᵢ^{x} is the probability that the x-th faulty battery pack in the faulty battery cluster is in the i-th state; gᵢ^{x} is the SOH level of the i-th state for the x-th faulty battery pack in the faulty battery cluster; Pᵢ^{h} is the probability that the h-th non-faulty battery pack in the faulty battery cluster is in the i-th state; gᵢ^{h} is the SOH level of the i-th state for the h-th non-faulty battery pack in the faulty battery cluster; \tilde{P}_{f,i} is the probability that the faulty battery cluster is in the i-th state; g_{f,i} is the SOH level of the i-th state for the faulty battery cluster.

Finally, the overall model of the five-state and four-level mixing precision energy storage battery compartment is established as follows.

$${u}_{bat} ( z ) = Ω ( {u}_{cluster . normal 1} ( z ) , … , {u}_{cluster . norma ln} ( z ) , {u}_{cluster . fault} ( z ) ) = {\sum }_{i = 1}^{n} {\tilde{P}}_{l , i} {z}^{{g}_{l , i}} \qquad ( 28 )$$

where u_{bat}(z) is a universal generating function value of the battery compartment; u_{cluster.normal1}(z) is a universal generating function value of a first non-faulty battery cluster; u_{cluster.normaln}(z) is a universal generating function value of the n-th non-faulty battery cluster; u_{pack.fault}(z) is a universal generating function value of a faulty battery cluster; P_{l,i} is the probability of the battery compartment being in the i-th state; g_{l,i} is the SOH level of the i-th state for the battery compartment.

In step 5, the calculation of the reliability of the battery uses the definition of the reliability in the multi-state system, that is, the probability that the performance level of the system is higher than the requirement level. Assuming that the minimum performance requirement level of the energy storage battery system is γ, the reliability of the energy storage battery can be calculated by using the formula (29) after the state probability of the battery energy storage system is calculated by using the proposed model.

$${R}_{l} = p \{ {g}_{l , i} \geq γ \} = {\sum }_{{g}_{l , i} \geq γ} {\tilde{P}}_{l , i} \qquad ( 29 )$$

where Rₗ is the reliability of the battery compartment; p{g_{l,i} ≥} is the probability that the state set of the battery compartment is greater than or equal to the minimum performance requirement level; and \tilde{P}_{l,i} is the probability set of the battery compartment.

Because the state probability of the battery uses the fuzzy probability, the fuzzy number about the reliability will be finally obtained. That is, the reliability of energy storage is not the only fixed value, and the possible value interval of the reliability and its membership degrees of different values will be given. Based on the membership function of the reliability, the confidence interval of the reliability under different confidence levels can be further acquired.

The expectation of the state of health of the energy storage battery system can be defined as the formula (30).

$${E}_{l} = {\sum }_{{g}_{l , i} \geq γ} {\tilde{P}}_{l , i} \cdot {g}_{l , i} \qquad ( 30 )$$

where Eₗ is the expectation of the state of health of the battery compartment.

Similarly, the expectation of the state of health is also denoted by the corresponding fuzzy number, and the confidence interval of different confidence levels can be obtained based on the membership function.

Embodiment 2 provides a system for modeling multi-state mixing precision of a battery energy storage container.

In this embodiment, the system for modeling multi-state mixing precision of the battery energy storage container includes a level dividing module, a state dividing module, a normal distribution model constructing module, a first function constructing module, a second function constructing module, and an overall model constructing module. The level dividing module is configured to divide a battery energy storage container into a four-level model, which in sequence includes: a battery cell level, a battery pack level, a battery cluster level, and a battery compartment level, where the battery compartment includes a plurality of battery clusters, each battery cluster includes a plurality of battery packs, and each battery pack includes a plurality of battery cells.

The state dividing module is configured to divide states of the battery cells into five states according to the states of health (SOHs) of the battery cells, where the five states include: excellence, attenuation, risk, defect and fault.

The normal distribution model constructing module is configured to construct a normal distribution model of the SOHs based on the five states of the battery cells and determine the probability of each battery cell in each state.

The first function constructing module is configured to construct a universal generating function of the battery cells based on the probability of each battery cell in each state and the SOH corresponding to each state.

The second function constructing module is configured to construct the universal generating function of the battery pack, the universal generating function of the battery cluster, and the universal generating function of the battery compartment based on the universal generating function of the battery cells.

The overall model constructing module is configured to construct an overall model of a five-state and four-level mixing precision energy storage battery compartment based on each universal generating function and an internal topological structure of the battery energy storage container.

Embodiment 3 provides a device, including a memory, a processor, and a computer program stored in the memory, where the processor operates the computer program to cause the device to implement the method for modeling multi-state mixing precision of the battery energy storage container in Embodiment 1.

In some embodiments, the memory is a readable storage medium.

In this specification, various embodiments are described in a progressive way. The differences between each embodiment and other embodiments are highlighted, and the same and similar parts of various embodiments can be referred to each other. Since the system provided in the embodiment corresponds to the method provided in the embodiment, the system is described simply. Refer to the description of the method for the relevant points.

In the present disclosure, specific examples are applied to illustrate the principle and implementation of the present disclosure, and the explanations of the above embodiments are only used to help understand the method and core ideas of the present disclosure. At the same time, according to the idea of the present disclosure, there will be some changes in the specific implementation and application scope for those skilled in the art. To sum up, the contents of the specification should not be construed as limiting the present disclosure.

What is claimed is:

1. A method for monitoring a battery energy storage container, comprising:
building a monitoring model for the battery energy storage container, comprising
dividing the battery energy storage container into a four-level model, which in sequence comprises a battery cell level, a battery pack level, a battery cluster level, and a battery compartment level, wherein a battery compartment comprises a plurality of battery clusters, each battery cluster comprises a plurality of battery packs, and each battery pack comprises a plurality of battery cells;
dividing states of the battery cells into five states according to states of health (SOHs) of the battery cells, wherein the five states comprise excellence, attenuation, risk, defect and fault;
constructing a normal distribution model of the SOHs based on the five states of the battery cells and determining a probability of each battery cell in each state;
constructing a universal generating function of the battery cells based on the probability of each battery cell in each state and the SOH corresponding to each state;
constructing a universal generating function of the battery pack, a universal generating function of the battery cluster, and a universal generating function of the battery compartment based on the universal generating function of the battery cells; and
constructing an overall model of a five-state and four-level mixing precision energy storage battery compartment based on each universal generating function and an internal topological structure of the battery energy storage container; wherein the overall model of a five-state and four-level mixing precision energy storage battery compartment is the monitoring model;
obtaining SOHs of battery cells in a target battery energy storage container;
calculating a reliability of the target battery energy storage container based on the obtained SOHs of the battery cells, using the monitoring model; and
replacing a battery cell that is in thermal runaway, in response to the reliability of the target battery energy storage container not being within a predetermined reliability interval.

2. The method according to claim 1, wherein the universal generating function of the battery cells is:
$${u}_{j} ( z ) = {\sum }_{i = 1}^{5} {P}_{i}^{j} {z}^{{g}_{i}^{j}} ;$$
wherein uⱼ(z) is a universal generating function value of a j-th battery cell; Pᵢ^{j} is a probability of the j-th battery cell being in an i-th state; z is a power coefficient; gᵢ^{j} is an SOH level of the i-th state for the j-th battery cell.

3. The method according to claim 2, wherein the universal generating function of each battery pack is:
u_{pack}(z)=Ω(u₁(z), u₂(z), u₃(z), . . . , uⱼ(z), . . . , u_{N}(z));
wherein u_{pack}(z)is a universal generating function value of the battery pack; u₁(z) is a universal generating function value of a first battery cell; u₂(z) is a universal generating function value of a second battery cell; u₃(z) is a universal generating function value of a third battery cell; uⱼ(z) is a universal generating function value of the j-th battery cell; u_{N}(z) is a universal generating function value of an N-th battery cell; N is a number of battery cells in the battery pack; and Ω(·) is a series-parallel operation.

4. The method according to claim 3, wherein the universal generating function of each battery cluster is:
u_{cluster}(z)=Ω(u_{pack1}(z), u_{pack2}(z), u_{pack3}(z), . . . , u_{packj1}(z), . . . , u_{packM}(z));
wherein u_{cluster}(z) is a universal generating function value of the battery cluster; u_{pack1}(z) is a universal generating function value of a first battery pack; u_{pack2}(z) is a universal generating function value of a second battery pack; u_{pack3}(z) is a universal generating function value of a third battery pack; u_{packj1}(z) is a universal generating function value of a j1-th battery pack; u_{packM}(z) is a universal generating function value of an M-th battery pack; and M is a number of battery packs in the battery cluster.

5. The method according to claim 4, wherein the universal generating function of the battery compartment is:
u_{bat}(z)=Ω(u_{cluster1}(z), u_{cluster2}(z), u_{cluster3}(z), . . . , u_{clusterj2}(z), . . . , u_{clusterK}(z));
wherein u_{bat}(z) is a universal generating function value of the battery compartment; u_{cluster1}(z) is a universal generating function value of a first battery cluster; u_{cluster2}(z) is a universal generating function value of a second battery cluster; u_{cluster3}(z) is a universal generating function value of a third battery cluster; u_{clusterj2}(z) is a universal generating function value of a j2-th battery cluster; u_{clusterK}(z) is a universal generating function value of a K-th battery cluster; and K is a number of battery clusters in the battery compartment.

6. The method according to claim 5, wherein the overall model of the five-state and four-level mixing precision energy storage battery compartment is:
u_{bat}(z)=Ω(u_{cluster.normal1}(z), . . . , u_{cluster.normaln}(z), u_{pack.fault}(z));
wherein u_{bat}(z) is the universal generating function value of the battery compartment; u_{cluster.normal1}(z) is a universal generating function value of a first non-faulty battery cluster; u_{cluster.normaln}(z) is a universal generating function value of an n-th non-faulty battery cluster; and u_{pack.fault}(z) is a universal generating function value of a faulty battery cluster.

7. A system for monitoring a battery energy storage container, wherein the system comprises:
a monitoring model for the battery energy storage container, comprising
a level dividing module, configured to divide the battery energy storage container into a four-level model, which in sequence comprises a battery cell level, a battery pack level, a battery cluster level, and a battery compartment level, wherein a battery compartment comprises a plurality of battery clusters, and each battery cluster comprises a plurality of battery packs, and each battery pack comprises a plurality of battery cells;
a state dividing module, configured to divide states of the battery cells into five states according to states of health (SOHs) of the battery cells, wherein the five states comprise excellence, attenuation, risk, defect and fault;
a normal distribution model constructing module, configured to construct a normal distribution model of the SOHs based on the five states of the battery cell and determine a probability of each battery cell in each state;
a first function constructing module, configured to construct a universal generating function of the battery cells based on the probability of each battery cell in each state and the SOH corresponding to each state;
a second function constructing module, configured to construct a universal generating function of the battery pack, a universal generating function of the battery cluster, and a universal generating function of the battery compartment based on the universal generating function of the battery cells; and
an overall model constructing module, configured to construct an overall model of a five-state and four-level mixing precision energy storage battery compartment based on each universal generating function and an internal topological structure of the battery energy storage container; wherein the overall model of a five-state and four-level mixing precision energy storage battery compartment is the monitoring model;
an obtaining module, configured to obtain SOHs of battery cells in a target battery energy storage container;
a calculation module, configured to calculate a reliability of the target battery energy storage container based on the obtained SOHs of the battery cells, using the monitoring model; and
an replacing module, configured to replace a battery cell that is in thermal runaway, in response to the reliability of the target battery energy storage container not being within a predetermined reliability interval.

8. A device, comprising:
a memory,
a processor, and
a computer program stored in the memory, wherein the processor operates the computer program to cause the device to implement the method according to claim 1.

9. The device according to claim 8, wherein the memory is a readable storage medium.

10. The device according to claim 8, wherein the universal generating function of the battery cells is:
$${u}_{j} ( z ) = {\sum }_{i = 1}^{5} {P}_{i}^{j} {z}^{{g}_{i}^{j}} ;$$
wherein uⱼ(z) is a universal generating function value of a j-th battery cell; Pᵢ^{j} is a probability of the j-th battery cell being in an i-th state; z is a power coefficient; gᵢ^{j} is an SOH level of the i-th state for the j-th battery cell.

11. The device according to claim 10, wherein the universal generating function of each battery pack is:
u_{pack}(z)=Ω(u₁(z), u₂(z), u₃(z), . . . , uⱼ(z), . . . , u_{N}(z))
wherein u_{pack}(z) is a universal generating function value of the battery pack; u₁(z) is a universal generating function value of a first battery cell; u₂(z) is a universal generating function value of a second battery cell; u₃(z) is a universal generating function value of a third battery cell; uⱼ(z) is a universal generating function value of the j-th battery cell; u_{N}(z) is a universal generating function value of an N-th battery cell; N is a number of battery cells in the battery pack; and Ω(·) is a series-parallel operation.

12. The device according to claim 11, wherein the universal generating function of each battery cluster is:
u_{cluster}(z)=Ω(u_{pack1}(z), u_{pack2}(z), u_{pack3}(z), . . . , u_{packj1}(z), . . . , u_{packM}(z));
wherein u_{cluster}(z) is a universal generating function value of the battery cluster; u_{pack1}(z) is a universal generating function value of a first battery pack; u_{pack2}(z) is a universal generating function value of a second battery pack; u_{pack3}(z) is a universal generating function value of a third battery pack; u_{packj1}(z) is a universal generating function value of a j1-th battery pack; u_{packM}(z) is a universal generating function value of an M-th battery pack; and M is a number of battery packs in the battery cluster.

13. The device according to claim 12, wherein the universal generating function of the battery compartment is:
u_{bat}(z)=Ω(u_{cluster1}(z), u_{cluster2}(z), u_{cluster3}(z), . . . , u_{clusterj2}(z), . . . , u_{clusterK}(z));
wherein u_{bat}(z) is a universal generating function value of the battery compartment; u_{cluster1}(z) is a universal generating function value of a first battery cluster; u_{cluster2}(z) is a universal generating function value of a second battery cluster; u_{cluster3}(z) is a universal generating function value of a third battery cluster; u_{clusterj2}(z) is a universal generating function value of a j2-th battery cluster; u_{clusterK}(z) is a universal generating function value of a K-th battery cluster; and K is a number of battery clusters in the battery compartment.

14. The device according to claim 13, wherein the overall model of the five-state and four-level mixing precision energy storage battery compartment is:
u_{bat}(z)=Ω(u_{cluster.normal1}(z), . . . , u_{cluster.normaln}(z), u_{cluster.fault}(z));
wherein u_{bat}(z) is the universal generating function value of the battery compartment; u_{cluster.normal1}(z) is a universal generating function value of a first non-faulty battery cluster; u_{cluster.normaln}(z) is a universal generating function value of an n-th non-faulty battery cluster; and u_{pack.fault}(z) is a universal generating function value of a faulty battery cluster.
